(19) United States
(12) Patent Application Publication
(10) Pub. No.: US 2022/0373006 A1
(43) Pub. Date: Nov. 24, 2022

(54) CONNECTING MECHANISM

(71) Applicant: Acer Incorporated, New Taipei City (TW)

(72) Inventor: Chi-Yuan LIU, New Taipei City (TW)

(21) Appl. No.: 17/741,646

(22) Filed: May 11, 2022

(30) Foreign Application Priority Data
May 19, 2021 (TW) 110118039

(51) Int. Cl. F16B 2/16

(52) U.S. Cl. CPC F16B 2/16

(57) ABSTRACT

A connecting mechanism is provided, including a first member, a second member, a first connecting element, a second connecting element, a resilient element, and a ball-shaped element. The first connecting element is connected to the second member. The first connecting element has an opening. The second connecting element is disposed in the first connecting element. The resilient element is connected between the second member and the second connecting element. When the first member moves to a joining position relative to the second member, a column of the first member extends through the opening, and the ball-shaped element is clamped between the first connecting element, the second connecting element and a recess of the column.

### CROSS REFERENCE TO RELATED APPLICATIONS

This Application claims priority of Taiwan Patent Application No. 110118039 filed on May 19, 2021, the entirety of which is incorporated by reference herein.

### BACKGROUND OF THE INVENTION

### Field of the Invention

The application relates in general to a connecting mechanism, and in particular, to a connecting mechanism that is easy to assemble and disassemble.

### Description of the Related Art

Conventional electronic devices or laptop computers usually have a plastic or metal housing. Since a number of threaded holes and screws are formed and disposed on the housing, assembly and disassembly of the housing can be difficult, and it is also hard to achieve a concise and simple appearance of the electronic device.

Therefore, designing a connecting mechanism for the housing of the electronic device that does not need screws has become a challenge.

### BRIEF SUMMARY OF INVENTION

A connecting mechanism is provided, including a first member, a second member, a first connecting element, a second connecting element, a resilient element, and a ball-shaped element. The first connecting element is connected to the second member and has an opening, the second connecting element is disposed in the first connecting element, and the resilient element is connected between the second member and the second connecting element. When the first member moves to a joining position relative to the second member, a column of the first member extends through the opening, and the ball-shaped element is clamped between the first connecting element, the second connecting element and a recess of the column.

### BRIEF DESCRIPTION OF DRAWINGS

The invention can be more fully understood by reading the subsequent detailed description and examples with references made to the accompanying drawings, wherein:

FIG. 1 is an exploded diagram of a connecting mechanism 100 according to an embodiment of the invention.

FIG. 2 is another exploded diagram of the connecting mechanism 100 in FIG. 1.

FIG. 3 is a perspective diagram of the first member 10 in FIGS. 1 and 2.

FIG. 4 is a perspective diagram of the first connecting element 30 in FIGS. 1 and 2.

FIG. 5 is another perspective diagram of the first connecting element 30 in FIGS. 1 and 2.

FIG. 6 is a perspective diagram of the second connecting element 40 and the ball-shaped elements B in FIGS. 1 and 2.

FIG. 7 is a perspective diagram of the second member 20 in FIGS. 1 and 2.

FIG. 8 is a perspective diagram of the connecting mechanism 100 in FIGS. 1 and 2 after assembly.

FIG. 9 is a cross-sectional view of the connecting mechanism 100 when the first member 10 is in the joining position relative to the second member 20.

FIG. 10 is a cross-sectional view of the connecting mechanism 100 with a pushing pin P inserted into the hole H1 of the first member 10.

FIG. 11 is another cross-sectional view of the connecting mechanism 100 in FIG. 10.

FIG. 12 is a cross-sectional view of the connecting mechanism 100, wherein the second connecting element 40 is forced by the pushing pin P to move toward the bottom of the second member 20.

FIG. 13 is another cross-sectional view of the connecting mechanism 100 in FIG. 12.

### DETAILED DESCRIPTION OF INVENTION

The making and using of the embodiments of the connecting mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

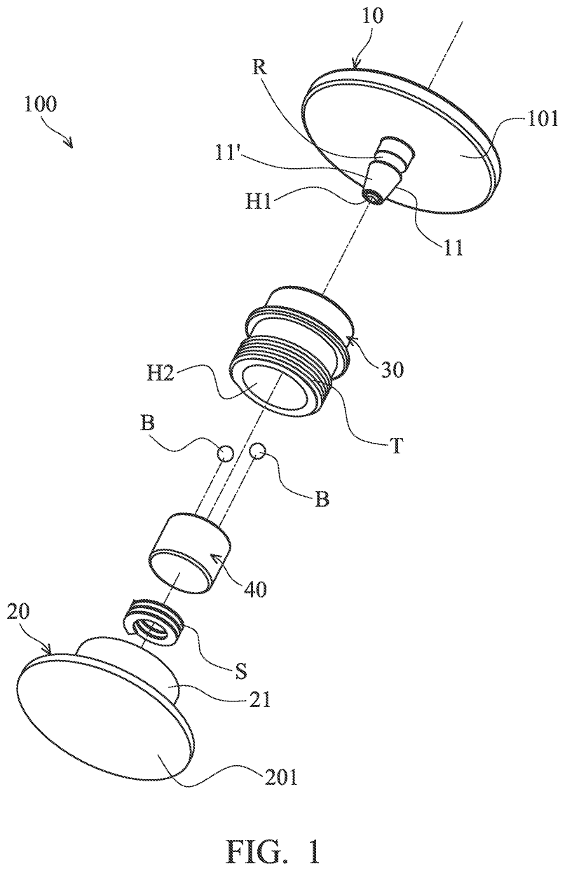

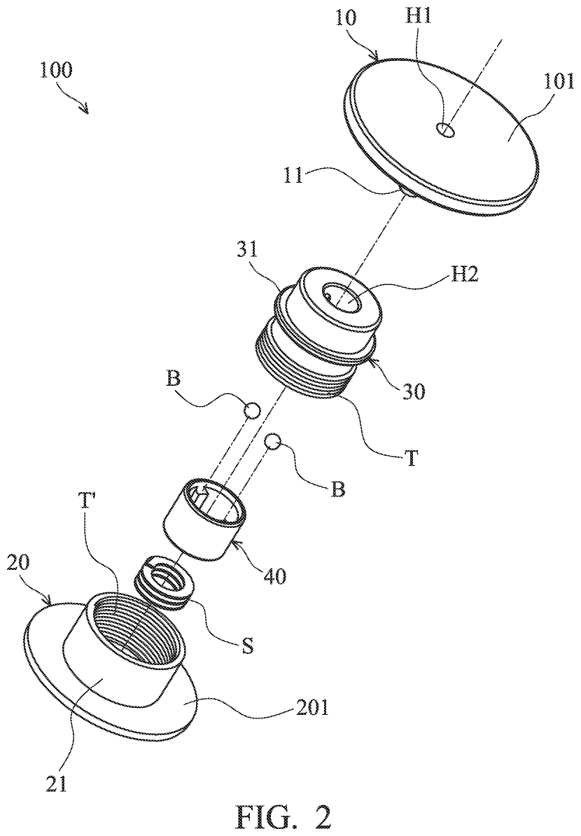

FIG. 1 is an exploded diagram of a connecting mechanism 100 according to an embodiment of the invention. FIG. 2 is another exploded diagram of the connecting mechanism 100 in FIG. 1.

Referring to FIGS. 1 and 2, an embodiment of a connecting mechanism 100 may be disposed in a laptop computer or other electronic devices. The connecting mechanism 100 primarily comprises a first member 10, a second member 20, a hollow first connecting element 30, a hollow second connecting element 40, a resilient element S, and at least a ball-shaped element B.

The first member 10 has a first flat portion 101, a column 11 protruding from the first flat portion 101, and a hole H1 extending through the first flat portion 101 and the column 11. Additionally, an annular recess R is formed on the outer surface of the column 11 (FIG. 1).

The second member 20 is detachably connected to the first member 10. Here, the second member 20 has a second flat portion 201 and a barrel portion 21 protruding from the second flat portion 201.

In some embodiments, the first member 10 and the second member 20 are connected to each other and constitute a housing of a laptop computer or other electronic devices. A chamber is formed between the first flat portion 101 of the first member 10 and the second flat portion 201 of the second member 20 for accommodating circuit boards, batteries or other electronic components. Here, the first flat portion 101 of the first member 10 and the second flat portion 201 of the second member 20 have a round structure. However, the first and second flat portions 101 and 201 may have other shapes as they serve as the upper and lower housings of an electronic device, but they are not limited to the embodiments of the invention.

The hollow first connecting element 30 is detachably connected to the barrel portion 21 of the second member 20. In this embodiment, a threaded structure T is formed on the outer surface of the first connecting element 30, and another threaded structure T′ is formed on the inner surface of barrel portion 21. The first connecting element 30 and the barrel portion 21 can be firmly secured to each other by connecting the threaded structures T and T′ (FIG. 2).

As shown in FIGS. 1 and 2, an opening H2 is formed through the first connecting element 30, and the hollow second connecting element 40 is movably received in the first connecting element 30.

The resilient element S may be a compression spring that is disposed in the barrel portion 21 of the second member 20. An end of the resilient element S abuts the bottom surface of the second connecting element 40, and the other end of the resilient element S abuts the second member 20 after assembly. Therefore, the resilient element S can provide a spring force to restrict the second connecting element 40 in the first connecting element 30.

It should be noted that when the first member 10 moves to a joining position relative to the second member 20, the column 11 of the first member 10 is inserted through the opening H2 at the center of the first connecting element 30, and the resilient element S exerts a spring force upwardly on the second connecting element 40, so that the ball-shaped elements B are clamped and restricted between the recess R on the column 11 of the first member 10 and the first and second connecting elements 30 and 40. Therefore, the first member 10 can be restricted in the joining position and firmly joined to the second member 20.

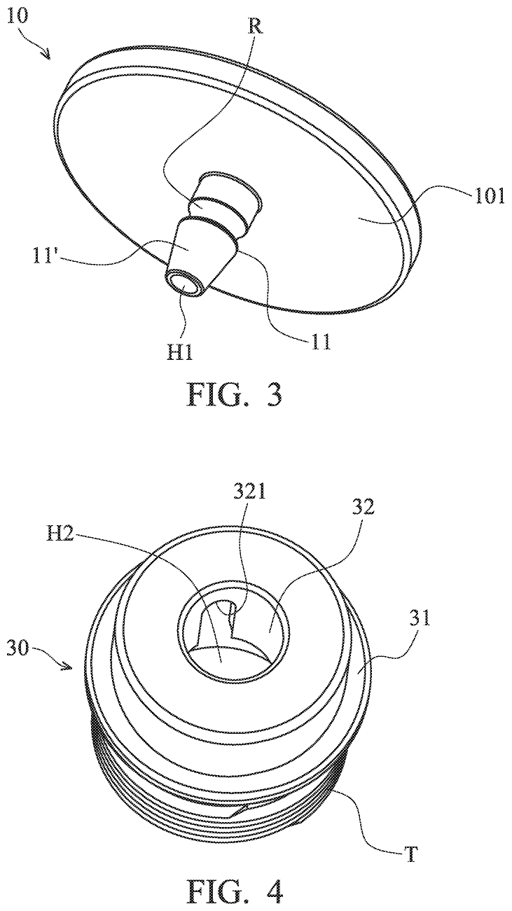

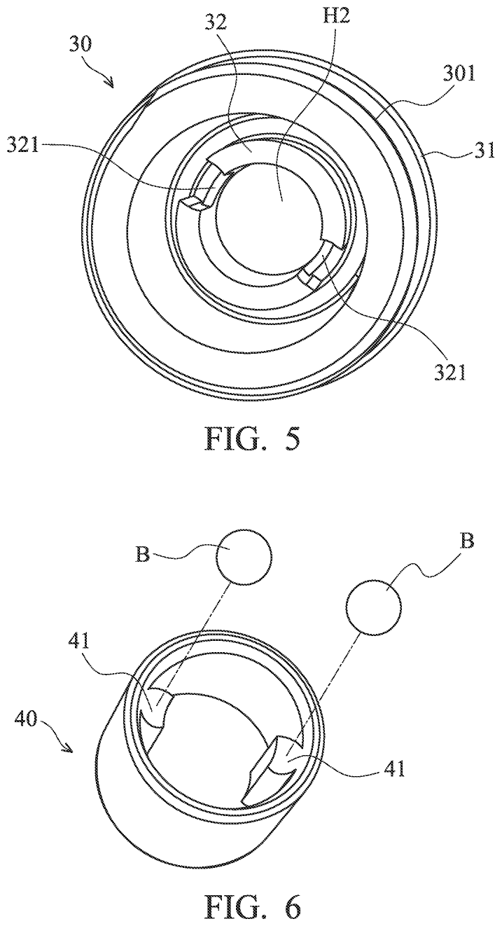

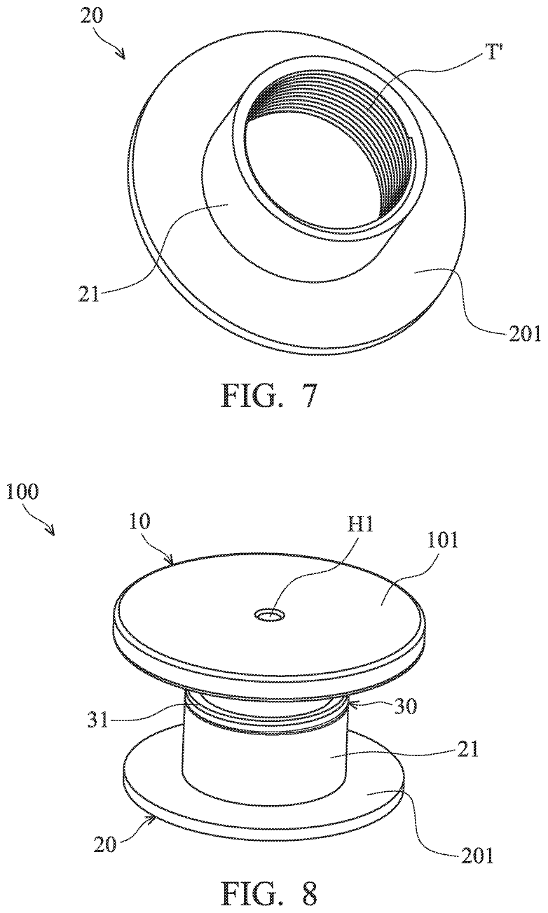

FIG. 3 is a perspective diagram of the first member 10 in FIGS. 1 and 2. FIG. 4 is a perspective diagram of the first connecting element 30 in FIGS. 1 and 2. FIG. 5 is another perspective diagram of the first connecting element 30 in FIGS. 1 and 2. FIG. 6 is a perspective diagram of the second connecting element 40 and the ball-shaped elements B in FIGS. 1 and 2. FIG. 7 is a perspective diagram of the second member 20 in FIGS. 1 and 2. FIG. 8 is a perspective diagram of the connecting mechanism 100 in FIGS. 1 and 2 after assembly.

Referring to FIGS. 1 and 3, the column 11 of the first member 10 has a slope surface 11′ surrounding the hole H1 and adjacent to the recess R, whereby a tapered structure is formed at an end of the column 11. Therefore, it can be much easier to insert the column 11 through the opening H2 of the first connecting element 30 during assembly of the connecting mechanism 100.

As shown in FIGS. 4 and 5, the first connecting element 30 has a hollow cylindrical structure. Specifically, an annular flange 31 is formed on the outer surface of the first connecting element 30, and an annular protrusion 32 is formed on the inner side of the first connecting element 30. The protrusion 32 surrounds the opening H2, and at least a cavity 321 is formed on the protrusion 32 (FIGS. 4 and 5) for receiving the ball-shaped element B.

Moreover, as shown in FIGS. 1 and 6, the second connecting element 40 has a cup-shaped structure. Specifically, at least a depressed portion 41 is formed on the inner side of the second connecting element 40 for receiving the ball-shaped element B. In this embodiment, when the first member 10 moves to the joining position relative to the second member 20, two ball-shaped elements B are clamped and restricted between the cavities 321 of the first connecting element 30, the depressed portions 41 of the second connecting element 40, and the recess R on the column 11 of the first member 10. Therefore, the first member 10 can be restricted in the joining position and firmly joined to the second member 20.

As shown in FIG. 7, a threaded structure T′ is formed on the inner surface of barrel portion 21, corresponding to the threaded structure T formed on the outer surface of the first connecting element 30. During assembly of the connecting mechanism 100, the first connecting element 30 is firmly secured to the second member 20 by connecting the threaded structures T and T′.

Subsequently, as shown in FIG. 8, the column 11 of the first member 10 can be inserted through the opening H2 at the center of the first connecting element 30, whereby the first member 10 moves to the joining position relative to the second member 20 (i.e. the first and second members 10 and 20 are joined with each other). In this state, the flange 31 of the first connecting element 30 is located adjacent to and the top of barrel portion 21 of the second member 20 and exposed to the outside of the connecting mechanism 100, and the resilient element S and the ball-shaped elements B are hidden and concealed by the first and second members 10 and 20.

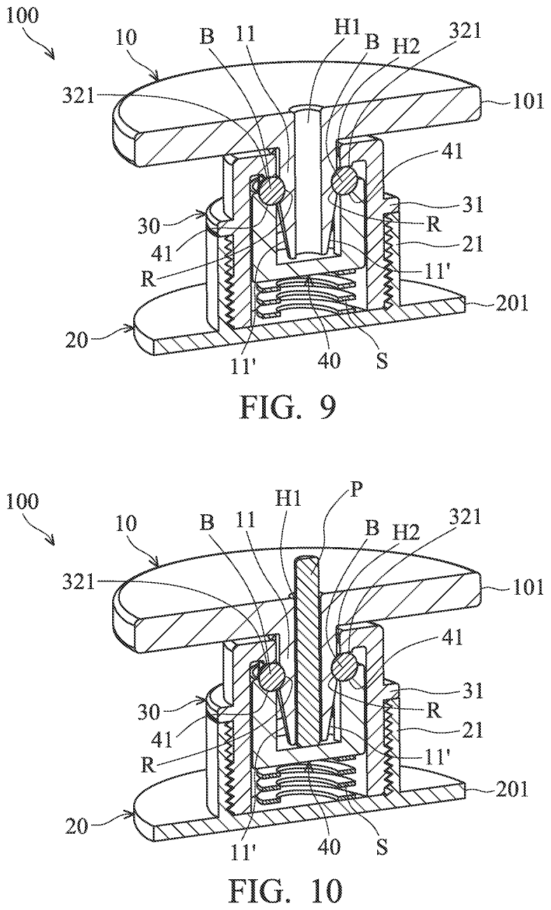

FIG. 9 is a cross-sectional view of the connecting mechanism 100 when the first member 10 is in the joining position relative to the second member 20. Referring to FIG. 9, when joining the first member 10 to the second member 20, the column 11 of the first member 10 is inserted through the opening H2 at the center of the first connecting element 30, so that the ball-shaped elements B slide along the slope surface 11′ at the end of the column 11 and move outwardly with respect to the center of the column 11. Additionally, since the resilient element S between the second member 20 and the second connecting element 40 continuously exerts a spring force upwardly on the second connecting element 40, the ball-shaped elements B are clamped and restricted between the cavities 321 of the first connecting element 30, the depressed portions 41 of the second connecting element 40, and the recess R on the column 11 of the first member 10. Therefore, the first member 10 is restricted in the joining position (FIG. 9) and firmly affixed to the second member 20.

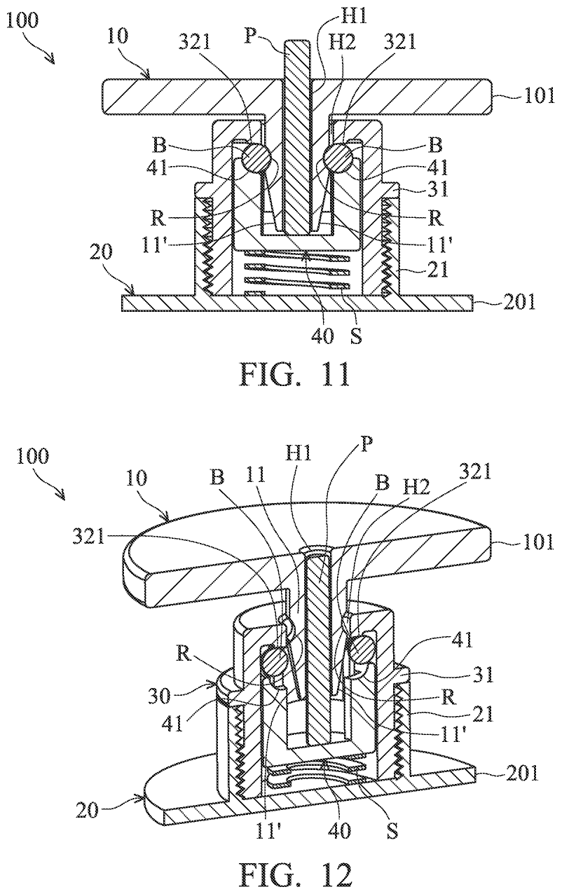

FIG. 10 is a cross-sectional view of the connecting mechanism 100 with a pushing pin P inserted into the hole H1 of the first member 10. FIG. 11 is another cross-sectional view of the connecting mechanism 100 in FIG. 10.

Referring to FIGS. 10 and 11, the connecting mechanism 100 further comprises a pushing pin P. To release the first member 10 from the second member 20, the pushing pin P can be inserted into the hole H1 of the first member 10 and push against the bottom of the second connecting element 40. Therefore, the second connecting element 40 is forced to move toward the bottom of the second member 20.

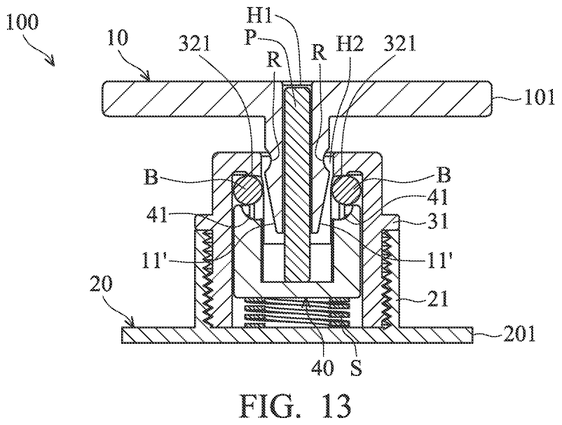

FIG. 12 is a cross-sectional view of the connecting mechanism 100, wherein the second connecting element 40 is forced by the pushing pin P to move toward the bottom of the second member 20. FIG. 13 is another cross-sectional view of the connecting mechanism 100 in FIG. 12.

Referring to FIGS. 12 and 13, as the pushing pin P is inserted through the hole H1 of the first member 10 and pushes the second connecting element 40 to a release position, the ball-shaped elements B are released from the cavities 321 of the first connecting element 30, the depressed portions 41 of the second connecting element 40, and the recess R on the column 11 of the first member 10. Subsequently, the column 11 of the first member 10 can be drawn out of the opening H2 of the first connecting element 30, so that the first member 10 is released from the joining position and disengaged from the second member 20.

In summary, the invention provides a connecting mechanism that includes a first member 10, a second member 20, a first connecting element 30, a second connecting element 40, a resilient element S, and at least a ball-shaped element B. To join the first member 10 to the second member 20, the column 11 of the first member 10 can be inserted through the opening H2 of the first connecting element 30, so that the ball-shaped elements B are clamped and restricted between the cavities 321 of the first connecting element 30, the depressed portions 41 of the second connecting element 40, and the recess R on the column 11 of the first member 10.

To release the first member 10 from the second member 20, the pushing pin P can be inserted into the hole H1 of the first member 10 and push the bottom of the second connecting element 40. Subsequently, the second connecting element 40 is moved toward the bottom of the second member 20 to a release position, so that the ball-shaped elements B are released from the cavities 321 of the first connecting element 30, the depressed portions 41 of the second connecting element 40, and the recess R on the column 11 of the first member 10. Therefore, the first member 10 can be released from the joining position and disengaged from the second member 20.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A connecting mechanism, comprising:
a first member, having a first flat portion, a column protruding from the first flat portion, and a hole extending through the first flat portion and the column, wherein a recess is formed on an outer surface of the column;
a second member, detachably connected to the first member, wherein the second member has a second flat portion and a barrel portion protruding from the second flat portion;
a hollow first connecting element, connected to the barrel portion and having an opening, wherein the opening extends through the first connecting element.
a hollow second connecting element, movably received in the first connecting element;
a resilient element, connected between the second member and the second connecting element, and
a ball-shaped element, wherein when the first member is in a joining position relative to the second member, the column of the first member extends through the opening, and the ball-shaped element is clamped between the first connecting element, the second connecting element and the recess of the column, thereby restricting the first member in the joining position.

2. The connecting mechanism as claimed in claim 1, wherein the column has a slope surface surrounding the hole and adjacent to the recess.

3. The connecting mechanism as claimed in claim 1, further comprising a pushing pin, wherein when the pushing pin is inserted through the hole of the first member and pushes the second connecting element to a released position, the ball-shaped element is released from the first connecting element, the second connecting element and the recess of the column, so that the first member is released from the joining position with respect to the second member.

4. The connecting mechanism as claimed in claim 1, wherein the first connecting element has a cavity, the second connecting element has a depressed portion, and the ball-shaped element is clamped between the cavity, the depressed portion, and the recess.

5. The connecting mechanism as claimed in claim 4, wherein the first connecting element further has an annular protrusion surrounding the opening, and the cavity is formed on the annular protrusion.

6. The connecting mechanism as claimed in claim 1, wherein the first connecting element and the barrel portion both have a threaded structure, and the first connecting element and the barrel portion are secured to each other by connecting the threaded structures.

7. The connecting mechanism as claimed in claim 1, wherein the first connecting element further has a flange adjacent to the barrel portion.

8. The connecting mechanism as claimed in claim 1, wherein the recess surrounds the hole of the first member.

9. The connecting mechanism as claimed in claim 1, wherein the first connecting element is received in the barrel portion.

10. The connecting mechanism as claimed in claim 1, wherein the second connecting element has a cup-shaped structure.
